(19) United States
(12) Patent Application Publication
(10) Pub. No.: US 2022/0374502 A1
(43) Pub. Date: Nov. 24, 2022

(54) METHOD AND APPARATUS FOR SUPPORTING DIGITAL RIGHTS MANAGEMENT IN MACHINE-TO-MACHINE SYSTEM

(71) Applicants: Hyundai Motor Company, Seoul (KR); Kia Corporation, Seoul (KR); Industry Academy Cooperation Foundation of Sejong University, Seoul (KR)

(72) Inventor: Jae Seung Song, Seoul (KR)

(21) Appl. No.: 17/746,169

(22) Filed: May 17, 2022

Related U.S. Application Data
(60) Provisional application No. 63/189,790, filed on May 18, 2021.

(51) Int. Cl. G06F 21/10; H04L 9/40

(52) U.S. Cl. CPC G06F 21/105; H04L 63/102; H04L 2209/603; H04L 2463/101

(57) ABSTRACT

Digital rights management (DRM) in a machine-to-machine (M2M) system, and a method for operating a first device may include: receiving, from a second device, a first message for requesting to create a resource associated with a content under digital rights management (DRM); creating the resource based on the first message; obtaining the content and right information on usage of the content from at least one external server; storing the content and the right information in the resource; and transmitting, to the second device, a second message for notifying creation of the resource.

### CROSS REFERENCE TO RELATED APPLICATION

The present application claims priority to a U.S. provisional application 63/189,790, filed May 18, 2021, the entire contents of which are incorporated herein for all purposes by this reference.

### BACKGROUND OF THE DISCLOSURE

### Field of the Disclosure

The present disclosure relates to a machine-to-machine (M2M) system and, more particularly, to a method and apparatus for supporting digital rights management (DRM) in an M2M system.

### Description of the Related Art

Recently, introduction of Machine-to-Machine (M2M) system has become active. An M2M communication may refer to a communication performed between machines without human intervention. M2M may refer to Machine Type Communication (MTC), Internet of Things (IoT) or Device-to-Device (D2D). In the following description, the term “M2M” may be uniformly used for convenience of explanation, but the present disclosure may not be limited thereto. A terminal used for M2M communication may be an M2M terminal or an M2M device. An M2M terminal may generally be a device having low mobility while transmitting a small amount of data. Herein, the M2M terminal may be used in connection with an M2M server that centrally stores and manages inter-machine communication information. In addition, an M2M terminal may be applied to various systems such as object tracking, automobile linkage, and power metering.

Meanwhile, with respect to an M2M terminal, the oneM2M standardization organization provides requirements for M2M communication, things to things communication and IoT technology, and technologies for architecture, Application Program Interface (API) specifications, security solutions and interoperability. The specifications of the oneM2M standardization organization provide a framework to support a variety of applications and services such as smart cities, smart grids, connected cars, home automation, security and health.

### SUMMARY

The present disclosure may be directed to provide a method and apparatus for effectively supporting digital rights management (DRM) in a machine-to-machine (M2M) system.

The present disclosure may be directed to provide a method and apparatus for supporting open mobile alliance (OMA) DRM in an M2M system.

The present disclosure may be directed to provide a method and apparatus for providing a resource for managing information necessary to train an artificial intelligence model in an M2M system.

According to an embodiment of the present disclosure, a method for operating a first device in a machine-to-machine (M2M) system may include: receiving, from a second device, a first message for requesting to create a resource associated with a content under digital rights management (DRM), creating the resource based on the first message, obtaining the content and right information on usage of the content from at least one external server, storing the content and the right information in the resource, and transmitting, to the second device, a second message for notifying that the resource is created.

According to an embodiment of the present disclosure, a method for operating a second device in a machine-to-machine (M2M) system may include: transmitting, to a first device, a first message for requesting to create a resource associated with a content under digital rights management (DRM), and receiving, from the first device, a second message for notifying that the resource is created.

According to an embodiment of the present disclosure, a first device in a machine-to-machine (M2M) system may include a transceiver and a processor coupled with the transceiver. The processor may be configured to: receive, from a second device, a first message for requesting to create a resource associated with a content under digital rights management (DRM), create the resource based on the first message, obtain the content and right information on usage of the content from at least one external server, store the content and the right information in the resource, and transmit, to the second device, a second message for notifying that the resource is created.

According to an embodiment of the present disclosure, a second device in a machine-to-machine (M2M) system may include a transceiver and a processor coupled with the transceiver. The processor may be configured to: transmit, to a first device, a first message for requesting to create a resource associated with a content under digital rights management (DRM), and receive, from the first device, a second message for notifying that the resource is created.

According to the present disclosure, digital rights management (DRM) contents may be effectively managed in a machine-to-machine (M2M) system.

In a further embodiment, a vehicle is provided that is configured to communicate with the in the machine-to-machine system as described herein.

### BRIEF DESCRIPTION OF THE DRAWINGS

The above and other objects, features and advantages of the present disclosure will be more clearly understood from the following detailed description taken in conjunction with the accompanying drawings.

FIG. 1 illustrates a layered structure of a machine-to-machine (M2M) system according to the present disclosure.

FIG. 2 illustrates a reference point in an M2M system according to the present disclosure.

FIG. 3 illustrates each node in an M2M system according to the present disclosure.

FIG. 4 illustrates a common service function in an M2M system according to the present disclosure.

FIG. 5 illustrates a method in which an originator and a receiver exchange a message in an M2M system according to the present disclosure.

FIG. 6 illustrates an example of an architecture for managing a resource associated with open mobile alliance (OMA) digital rights management (DRM) in an M2M system according to the present disclosure.

FIG. 7 illustrates interaction between entities associated with contents under OMA DRM in an M2M system according to the present disclosure.

FIG. 8 illustrates an example of an architecture of a resource associated with OMA DRM in an M2M system according to the present disclosure.

FIG. 9 illustrates an example of a procedure for creating a resource associated with DRM contents in an M2M system according to the present disclosure.

FIG. 10 illustrates an example of a procedure for providing contents stored in a resource associated with DRM contents in an M2M system according to the present disclosure.

FIG. 11 illustrates an example of a procedure for creating a resource containing DRM contents and right information in an M2M system according to the present disclosure.

FIG. 12 illustrates an example of a procedure for providing DRM contents based on rights information in an M2M system according to the present disclosure.

FIG. 13 illustrates a configuration of an M2M device in an M2M system according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, embodiments of the present disclosure will be described in detail with reference to the accompanying drawings, which will be easily implemented by those skilled in the art. However, the present disclosure may be embodied in many different forms and may not be limited to the exemplary embodiments described herein.

In the present disclosure, the terms first, second, etc. may be used only for the purpose of distinguishing one component from another, and do not limit the order or importance of components, etc. unless specifically stated otherwise. Thus, within the scope of this disclosure, a first component in one embodiment may be referred to as a second component in another embodiment, and similarly a second component in one embodiment may be referred to as a first component.

In the present disclosure, when a component may be referred to as being “linked”, “coupled”, or “connected” to another component, it may be understood that not only a direct connection relationship but also an indirect connection relationship through an intermediate component may also be included. Also, when a component may be referred to as “comprising” or “having” another component, it may mean further inclusion of another component not the exclusion thereof, unless explicitly described to the contrary.

In the present disclosure, components that may be distinguished from each other may be intended to clearly illustrate each feature. However, it does not necessarily mean that the components may be separate. In other words, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment may be also included within the scope of the present disclosure. Also, exemplary embodiments that include other components in addition to the components described in the various exemplary embodiments may also be included in the scope of the present disclosure.

In the following description of the embodiments of the present disclosure, a detailed description of known functions and configurations incorporated herein will be omitted when it may make the subject matter of the present disclosure rather unclear. Parts not related to the description of the present disclosure in the drawings may be omitted, and like parts may be denoted by similar reference numerals.

Although an exemplary embodiment may be described as using a plurality of units to perform the exemplary process, it may be understood that the exemplary processes may also be performed by one or plurality of modules. Additionally, it may be understood that the term controller/control unit refers to a hardware device that includes a memory and a processor and may be specifically programmed to execute the processes described herein. The memory may be configured to store the modules and the processor may be specifically configured to execute said modules to perform one or more processes which may be described further below.

In addition, the present specification describes a network based on Machine-to-Machine (M2M) communication, and a work in M2M communication network may be performed in a process of network control and data transmission in a system managing the communication network. In the present specification, an M2M terminal may be a terminal performing M2M communication. However, in consideration of backward compatibility, it may be a terminal operating in a wireless communication system. In other words, an M2M terminal may refer to a terminal operating based on M2M communication network but may not be limited thereto. An M2M terminal may operate based on another wireless communication network and may not be limited to the exemplary embodiment described above.

In addition, an M2M terminal may be fixed or have mobility. An M2M server refers to a server for M2M communication and may be a fixed station or a mobile station. In the present specification, an entity may refer to hardware like M2M device, M2M gateway and M2M server. In addition, for example, an entity may be used to refer to software configuration in a layered structure of M2M system and may not be limited to the embodiment described above.

In addition, for example, the present disclosure mainly describes an M2M system but may not be solely applied thereto. In addition, an M2M server may be a server that performs communication with an M2M terminal or another M2M server. In addition, an M2M gateway may be a connection point between an M2M terminal and an M2M server. For example, when an M2M terminal and an M2M server have different networks, the M2M terminal and the M2M server may be connected to each other through an M2M gateway. Herein, for example, both an M2M gateway and an M2M server may be M2M terminals and may not be limited to the embodiment described above.

The present disclosure relates to a method and apparatus for supporting digital rights management (DRM) in a machine-to-machine (M2M) system. More particularly, the present disclosure describes a technology of managing a resource for storing and using contents having DRM in an M2M system.

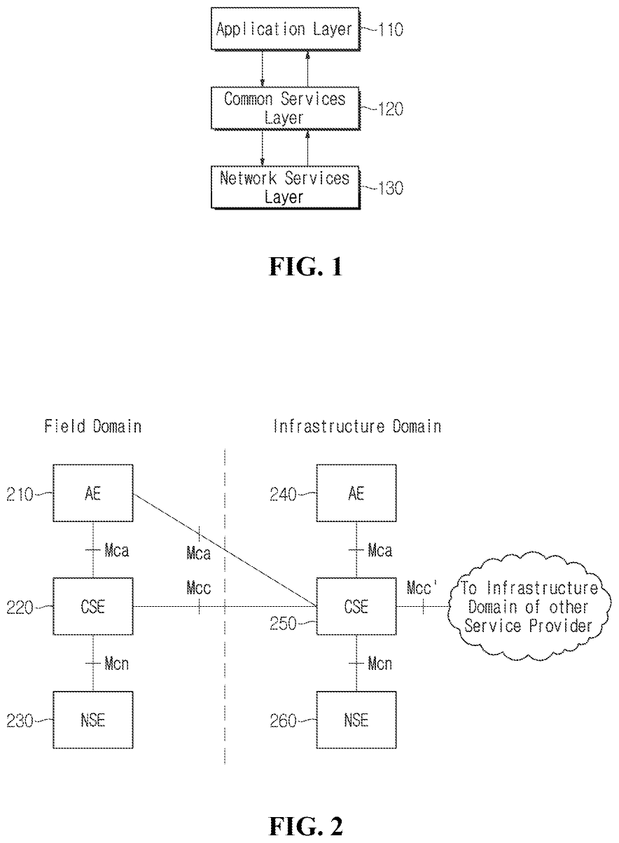

oneM2M may be a de facto standards organization that was founded to develop a communal IoT service platform sharing and integrating application service infrastructure (platform) environments beyond fragmented service platform development structures limited to separate industries like energy, transportation, national defense and public service. oneM2M aims to render requirements for things to things communication and IoT technology, architectures, Application Program Interface (API) specifications, security solutions and interoperability. For example, the specifications of oneM2M provide a framework to support a variety of applications and services such as smart cities, smart grids, connected cars, home automation, security and health. In this regard, oneM2M has developed a set of standards defining a single horizontal platform for data exchange and sharing among all the applications. Applications across different industrial sections may also be considered by oneM2M. Like an operating system, oneM2M provides a framework connecting different technologies, thereby creating distributed software layers facilitating unification. Distributed software layers may be implemented in a common services layer between M2M applications and communication Hardware/Software (HW/SW) rendering data transmission. For example, a common services layer may be a part of a layered structure illustrated in FIG. 1. The oneM2M standards are referred to herein and incorporated in their entirety into this application. Specifically, the technical specification of the oneM2M Functional Architecture is referred to herein and incorporated herein in its entirety. See Document No. TS-0001-V4.8.0, Functional Architecture and Document No. TS-0001-V3.15.1, Functional Architecture.

FIG. 1 illustrates a layered structure of an Machine-to-Machine (M2M) system according to the present disclosure. Referring to FIG. 1, a layered structure of an M2M system may include an application layer 110, a common services layer 120 and a network services layer 130. Herein, the application layer 110 may be a layer operating based on a specific application. For example, an application may be a fleet tracking application, a remote blood sugar monitoring application, a power metering application or a controlling application. In other words, an application layer may be a layer for a specific application. Herein, an entity operating based on an application layer may be an application entity (AE).

The common services layer 120 may be a layer for a common service function (CSF). For example, the common services layer 120 may be a layer for providing common services like data management, device management, M2M service subscription management and location service. For example, an entity operating based on the common services layer 120 may be a common service entity (CSE).

The common services layer 120 may provide a set of services that may be grouped into CSFs according to functions. A multiplicity of instantiated CSFs constitutes CSEs. CSEs may interface with applications (for example, application entities or AEs in the terminology of oneM2M), other CSEs and base networks (for example, network service entities or NSEs in the terminology of oneM2M). The network services layer 130 may provide the common services layer 120 with services such as device management, location service and device triggering. Herein, an entity operating based on the network layer 120 may be a network service entity (NSE).

FIG. 2 illustrates reference points in an M2M system according to the present disclosure. Referring to FIG. 2, an M2M system structure may be distinguished into a field domain and an infrastructure domain. Herein, in each domain, each of the entities may perform communication through a reference point (for example, Mca or Mcc). For example, a reference point may indicate a communication flow between each entity. In particular, referring to FIG. 2, the reference point Mca between AE 210 or 240 and CSE 220 or 250, the reference point Mcc between different CSEs and Mcn reference point between CSE 220 or 250 and NSE 230 or 260 may be set.

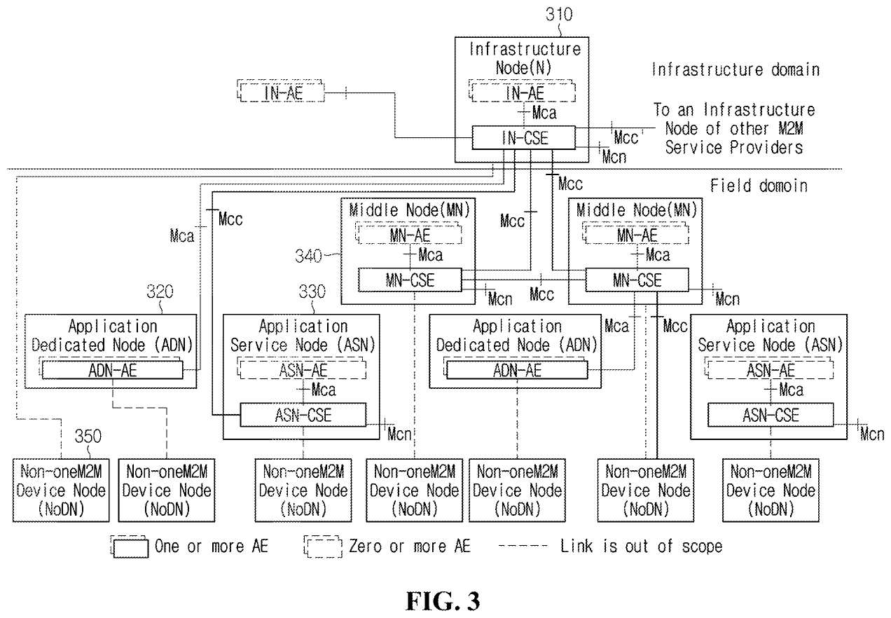

FIG. 3 illustrates each node in an M2M system according to the present disclosure. Referring to FIG. 3, an infrastructure domain of a specific M2M service provider may provide a specific infrastructure node (IN) 310. Herein, the CSE of the IN may be configured to perform communication based on the AE and the reference point Mca of another infrastructure node. In particular, one IN may be set for each M2M service provider. In other words, the IN may be a node that performs communication with the M2M terminal of another infrastructure based on an infrastructure structure. In addition, for example, conceptually, a node may be a logical entity or a software configuration.

Next, an application dedicated node (ADN) 320 may be a node including at least one AE but not CSE. In particular, an ADN may be set in the field domain. In other words, an ADN may be a dedicated node for AE. For example, an ADN may be a node that may be set in an M2M terminal in hardware. In addition, the application service node (ASN) 330 may be a node including one CSE and at least one AE. ASN may be set in the field domain. In other words, it may be a node including AE and CSE. In particular, an ASN may be a node connected to an IN. For example, an ASN may be a node that may be set in an M2M terminal in hardware.

In addition, a middle node (MN) 340 may be a node including a CSE and including zero or more AEs. In particular, the MN may be set in the field domain. An MN may be connected to another MN or IN based on a reference point. In addition, for example, an MN may be set in an M2M gateway in hardware. As an example, a non-M2M terminal node 350 (Non-M2M device node. NoDN) may be a node that does not include M2M entities. It may be a node that performs management or collaboration together with an M2M system.

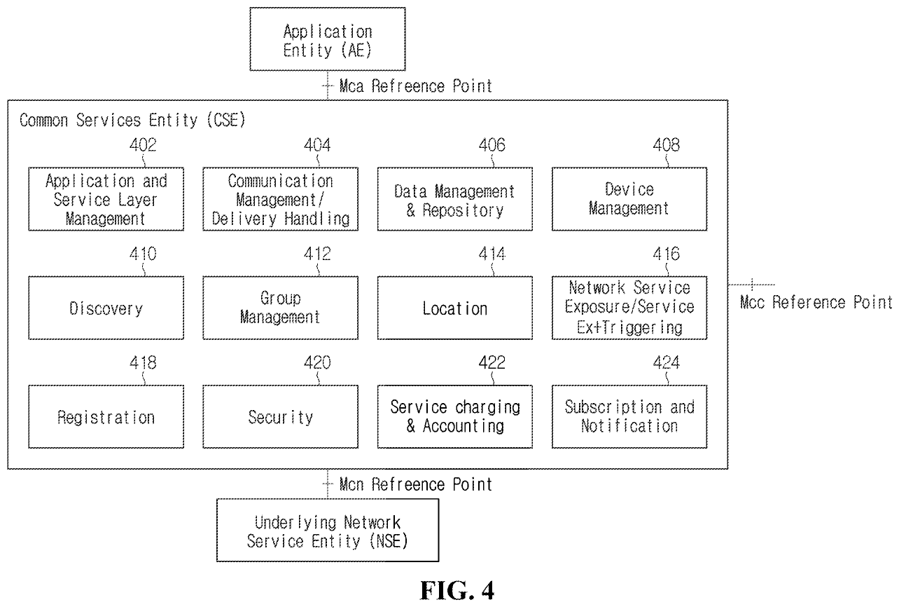

FIG. 4 illustrates a common service function in an M2M system according to the present disclosure. Referring to FIG. 4, common service functions may be provided. For example, a common service entity may provide at least one or more CSFs among application and service layer management 402, communication management and delivery handling 404, data management and repository 406, device management 408, discovery 410, group management 412, location 414, network service exposure/service execution and triggering 416, registration 418, security 420, service charging and accounting 422, service session management and subscription/notification 424. At this time, M2M terminals may operate based on a common service function. In addition, a common service function may be possible in other embodiments and may not be limited to the above-described exemplary embodiment.

The application and service layer management 402 CSF provides management of AEs and CSEs. The application and service layer management 402 CSF includes not only the configuring, problem solving and upgrading of CSE functions but also the capability of upgrading AEs. The communication management and delivery handling 404 CSF provides communications with other CSEs, AEs and NSEs. The communication management and delivery handling 404 CSF may be configured to determine at what time and through what connection communications may be delivered, and also determine to buffer communication requests to deliver the communications later, if necessary and permitted.

The data management and repository 406 CSF provides data storage and transmission functions (for example, data collection for aggregation, data reformatting, and data storage for analysis and sematic processing). The device management 408 CSF provides the management of device capabilities in M2M gateways and M2M devices.

The discovery 410 CSF may be configured to provide an information retrieval function for applications and services based on filter criteria. The group management 412 CSF provides processing of group-related requests. The group management 412 CSF enables an M2M system to support bulk operations for many devices and applications. The location 414 CSF may be configured to enable AEs to obtain geographical location information.

The network service exposure/service execution and triggering 416 CSF manages communications with base networks for access to network service functions. The registration 418 CSF may be configured to provide AEs (or other remote CSEs) to a CSE. The registration 418 CSF allows AEs (or remote CSE) to use services of CSE. The security 420 CSF may be configured to provide a service layer with security functions like access control including identification, authentication and permission. The service charging and accounting 422 CSF may be configured to provide charging functions for a service layer. The subscription/notification 424 CSF may be configured to allow subscription to an event and notifying the occurrence of the event.

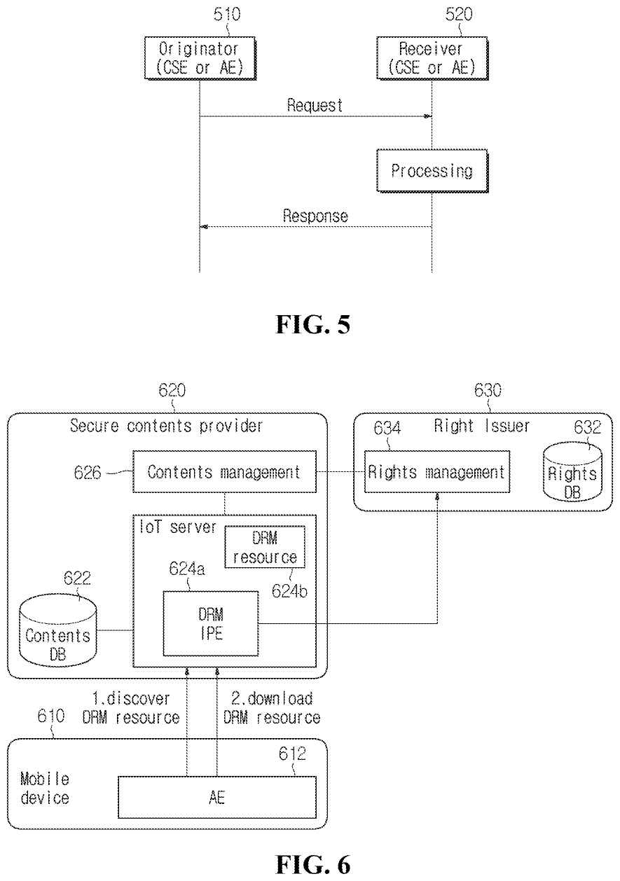

FIG. 5 illustrates an exchange of a message between an originator and a receiver in an M2M system according to the present disclosure. Referring to FIG. 5, the originator 501 may be configured to transmit a request message to the receiver 520. In particular, the originator 510 and the receiver 520 may be the above-described M2M terminals. However, the originator 510 and the receiver 520 may not be limited to M2M terminals but may be other terminals. They may not be limited to the above-described exemplary embodiment. In addition, for example, the originator 510 and the receiver 520 may be nodes, entities, servers or gateways, which may be described above. In other words, the originator 510 and the receiver 520 may be hardware or software configurations and may not be limited to the above-described embodiment.

Herein, for example, a request message transmitted by the originator 510 may include at least one parameter. Additionally, a parameter may be a mandatory parameter or an optional parameter. For example, a parameter related to a transmission terminal, a parameter related to a receiving terminal, an identification parameter and an operation parameter may be mandatory parameters. In addition, optional parameters may be related to other types of information. In particular, a transmission terminal-related parameter may be a parameter for the originator 510. In addition, a receiving terminal-related parameter may be a parameter for the receiver 520. An identification parameter may be a parameter required for identification of each other.

Further, an operation parameter may be a parameter for distinguishing operations. For example, an operation parameter may be set to any one among Create, Retrieve, Update, Delete or Notify. In other words, the parameter may aim to distinguish operations. In response to receiving a request message from the originator 510, the receiver 520 may be configured to process the message. For example, the receiver 520 may be configured to perform an operation included in a request message. For the operation, the receiver 520 may be configured to determine whether a parameter may be valid and authorized. In particular, in response to determining that a parameter may be valid and authorized, the receiver 520 may be configured to check whether there may be a requested resource and perform processing accordingly.

For example, in case an event occurs, the originator 510 may be configured to transmit a request message including a parameter for notification to the receiver 520. The receiver 520 may be configured to check a parameter for a notification included in a request message and may perform an operation accordingly. The receiver 520 may be configured to transmit a response message to the originator 510.

A message exchange process using a request message and a response message, as illustrated in FIG. 5, may be performed between AE and CSE based on the reference point Mca or between CSEs based on the reference point Mcc. In other words, the originator 510 may be AE or CSE, and the receiver 520 may be AE or CSE. According to an operation in a request message, such a message exchange process as illustrated in FIG. 5 may be initiated by either AE or CSE.

A request from a requestor to a receiver through the reference points Mca and Mcc may include at least one mandatory parameter and at least one optional parameter. In other words, each defined parameter may be either mandatory or optional according to a requested operation. For example, a response message may include at least one parameter among those listed in Table 1 below.

TABLE 1

Response message parameter/success or not
Response Status Code-successful, unsuccessful, ack
Request Identifier-uniquely identifies a Request message
Content-to be transferred
To-the identifier of the Originator or the Transit CSE
that sent the corresponding non-blocking request
From-the identifier of the Receiver
Originating Timestamp-when the message was built
Result Expiration Timestamp-when the message expires
Event Category-what event category shall be used for the response message
Content Status
Content Offset
Token Request Information
Assigned Token Identifiers
Authorization Signature Request Information
Release Version Indicator-the oneM2M release version
that this response message conforms to

A filter criteria condition, which may be used in a request message or a response message, may be defined as in Table 2 and Table 3 below.

TABLE 2

| | | |
|---|---|---|
| | Multi- | |
| Condition tag | plicity | Description |

Matching Conditions

| | | |
|---|---|---|
| createdBefore | 0 . . . 1 | The creationTime attribute of the matched resource is |
| | | chronologically before the specified value. |
| createdAfter | 0 . . . 1 | The creationTime attribute of the matched resource is |
| | | chronologically after the specified value. |
| modifiedSince | 0 . . . 1 | The lastModifiedTime attribute of the matched resource is |
| | | chronologically after the specified value. |
| unmodifiedSince | 0 . . . 1 | The lastModifiedTime attribute of the matched resource is |
| | | chronologically before the specified value. |
| stateTagSmaller | 0 . . . 1 | The stateTag attribute of the matched resource is smaller |
| | | than the specified value. |
| stateTagBigger | 0 . . . 1 | The stateTag attribute of the matched resource is bigger than the |
| | | specified value. |
| expireBefore | 0 . . . 1 | The expirationTime attribute of the matched resource is |
| | | chronologically before the specified value. |
| expireAfter | 0 . . . 1 | The expirationTime attribute of the matched resource is |
| | | chronologically after the specified value. |
| labels | 0 . . . 1 | The labels attribute of the matched resource matches the specified |
| | | value. |
| labelsQuery | 0 . . . 1 | The value is an expression for the filtering of labels attribute of |
| | | resource when it is of key-value pair format. The expression is |
| | | about the relationship between label-key and label-value which |
| | | may include equal to or not equal to, within or not within a |
| | | specified set etc. For example, label-key equals to label value, or |
| | | label-key within {label-value 1, label-value2}. |
| childLabels | 0 . . . 1 | A child of the matched resource has labels attributes matching the |
| | | specified value. The evaluation is the same as for the labels |
| | | attribute above. |
| parentLabels | 0 . . . 1 | The parent of the matched resource has labels attributes matching |
| | | the specified value. The evaluation is the same as for the labels |
| | | attribute above. |
| resourceType | 0 . . . n | The resourceType attribute of the matched resource is the same as |
| | | the specified value. It also allows differentiating between normal |
| | | and announced resources. |
| childResourceType | 0 . . . n | A child of the matched resource has the resourceType attribute the |
| | | same as the specified value. |
| parentResourceType | 0 . . . 1 | The parent of the matched resource has the resourceType attribute |
| | | the same as the specified value. |
| sizeAbove | 0 . . . 1 | The contentsize attribute of the <contentInstance> matched |
| | | resource is equal to or greater than the specified value. |
| sizeBelow | 0 . . . 1 | The contentsize attribute of the <contentInstance> matched |
| | | resource is smaller than the specified value. |
| contentType | 0 . . . n | The contentinfo attribute of the <contentInstance> matched |
| | | resource matches the specified value. |
| attribute | 0 . . . n | This is an attribute of resource types (clause 9.6). Therefore, a real |
| | | tag name is variable and depends on its usage and the value of the |
| | | attribute can have wild card *. E.g. creator of container resource |
| | | type can be used as a filter criteria tag as “creator = Sam”, |
| | | “creator = Sam*”, “creator = * Sam”. |
| childAttribute | 0 . . . n | A child of the matched resource meets the condition provided. |
| | | The evaluation of this condition is similar to the attribute |
| | | matching condition above. |
| parentAttribute | 0 . . . n | The parent of the matched resource meets the condition provided. |
| | | The evaluation of this condition is similar to the attribute |
| | | matching condition above. |
| semanticsFilter | 0 . . . n | Both semantic resource discovery and semantic query use |
| | | semanticsFilter to specify a query statement that shall be specified |
| | | in the SPARQL query language [5]. When a CSE receives a |
| | | RETRIEVE request including a semanticsFilter, and the Semantic |
| | | Query Indicator parameter is also present in the request, the |
| | | request shall be processed as a semantic query; otherwise, the |
| | | request shall be processed as a semantic resource discovery. |
| | | In the case of semantic resource discovery targeting a specific |
| | | resource, if the semantic description contained in the |
| | | <semanticDescriptor> of a child resource matches the |
| | | semanticFilter, the URI of this child resource will be included in |
| | | the semantic resource discovery result. |
| | | In the case of semantic query, given a received semantic query |
| | | request and its query scope, the SPARQL query statement shall be |
| | | executed over aggregated semantic information collected from the |
| | | semantic resource(s) in the query scope and the produced output |
| | | will be the result of this semantic query. |
| | | Examples for matching semantic filters in SPARQL to semantic |
| | | descriptions can be found in [i.28]. |
| filterOperation | 0 . . . 1 | Indicates the logical operation (AND/OR) to be used for different |
| | | condition tags. The default value is logical AND. |
| contentFilterSyntax | 0 . . . 1 | Indicates the Identifier for syntax to be applied for content-based |
| | | discovery. |
| contentFilterQuery | 0 . . . 1 | The query string shall be specified when contentFilterSyntax |
| | | parameter is present. |

TABLE 3

| | | |
|---|---|---|
| | Multi- | |
| Condition tag | plicity | Description |

Filter Handling Conditions

| | | |
|---|---|---|
| filterUsage | 0 . . . 1 | Indicates how the filter criteria is used. If provided, possible values |
| | | are ‘discovery’ and ‘IPEOnDemandDiscovery’. |
| | | If this parameter is not provided, the Retrieve operation is a |
| | | generic retrieve operation and the content of the child resources |
| | | fitting the filter criteria is returned. |
| | | If filterUsage is ‘discovery’, the Retrieve operation is for resource |
| | | discovery (clause 10.2.6), i.e. only the addresses of the child |
| | | resources are returned. |
| | | If filterUsage is ‘IPEOnDemandDiscovery’, the other filter |
| | | conditions are sent to the IPE as well as the discovery Originator |
| | | ID. When the IPE successfully generates new resources matching |
| | | with the conditions, then the resource address(es) shall be returned. |
| | | This value shall only be valid for the Retrieve request targeting an |
| | | <AE> resource that represents the IPE. |
| limit | 0 . . . 1 | The maximum number of resources to be included in the filtering |
| | | result. This may be modified by the Hosting CSE. When it is |
| | | modified, then the new value shall be smaller than the suggested |
| | | value by the Originator. |
| level | 0 . . . 1 | The maximum level of resource tree that the Hosting CSE shall |
| | | perform the operation starting from the target resource (i.e. To |
| | | parameter). This shall only be applied for Retrieve operation. The |
| | | level of the target resource itself is zero and the level of the direct |
| | | children of the target is one. |
| offset | 0 . . . 1 | The number of direct child and descendant resources that a Hosting |
| | | CSE shall skip over and not include within a Retrieve response |
| | | when processing a Retrieve request to a targeted resource. |
| applyRelativePath | 0 . . . 1 | This attribute contains a resource tree relative path |
| | | (e.g. . . . /tempContainer/LATEST). This condition applies after all |
| | | the matching conditions have been used (i.e. a matching result has |
| | | been obtained). The attribute determines the set of resource(s) in |
| | | the final filtering result. The filtering result is computed by |
| | | appending the relative path to the path(s) in the matching result. |
| | | All resources whose Resource-IDs match that combined path(s) |
| | | shall be returned in the filtering result. If the relative path does not |
| | | represent a valid resource, the outcome is the same as if no match |
| | | was found, i.e. there is no corresponding entry in the filtering |
| | | result. |

A response to a request for accessing a resource through the reference points Mca and Mcc may include at least one mandatory parameter and at least one optional parameter. In other words, each defined parameter may be either mandatory or optional according to a requested operation or a mandatory response code. For example, a request message may include at least one parameter among those listed in Table 4 below.

TABLE 4
Request message parameter

| | |
|---|---|
| Mandatory | Operation-operation to be executed/CREAT, Retrieve, Update, Delete, Notify |
| | To-the address of the target resource on the target CSE |
| | From-the identifier of the message Originator |
| | Request Identifier-uniquely identifies a Request message |
| Operation | Content-to be transferred |
| dependent | Resource Type-of resource to be created |
| Optional | Originating Timestamp-when the message was built |
| | Request Expiration Timestamp-when the request message expires |
| | Result Expiration Timestamp-when the result message expires |
| | Operational Execution Time-the time when the specified operation is to be |
| | executed by the target CSE |
| | Response Type-type of response that shall be sent to the Originator |
| | Result Persistence-the duration for which the reference containing the responses is |
| | to persist |
| | Result Content-the expected components of the result |
| | Event Category-indicates how and when the system should deliver the message |
| | Delivery Aggregation-aggregation of requests to the same target CSE is to be used |
| | Group Request Identifier-Identifier added to the group request that is to be fanned |
| | out to each member of the group |
| | Group Request Target Members-indicates subset of members of a group |
| | Filter Criteria-conditions for filtered retrieve operation |
| | Desired Identifier Result Type-format of resource identifiers returned |
| | Token Request Indicator-indicating that the Originator may attempt Token Request |
| | procedure (for Dynamic Authorization) if initiated by the Receiver |
| | Tokens-for use in dynamic authorization |
| | Token IDs-for use in dynamic authorization |
| | Role IDs-for use in role based access control |
| | Local Token IDs-for use in dynamic authorization |
| | Authorization Signature Indicator-for use in Authorization Relationship Mapping |
| | Authorization Signature-for use in Authorization Relationship Mapping |
| | Authorization Relationship Indicator-for use in Authorization Relationship |
| | Mapping |
| | Semantic Query Indicator-for use in semantic queries |
| | Release Version Indicator-the oneM2M release version that this request message |
| | conforms to. |
| | Vendor Information |

A normal resource includes a complete set of representations of data constituting the base of information to be managed. Unless qualified as either “virtual” or “announced”, the resource types in the present document may be normal resources. A virtual resource may be used to trigger processing and/or a retrieve result. However, a virtual resource may not have a permanent representation in a CSE. An announced resource may contain a set of attributes of an original resource. When an original resource changes, an announced resource may be automatically updated by the hosting CSE of the original resource. The announced resource contains a link to the original resource. Resource announcement enables resource discovery. An announced resource at a remote CSE may be used to create a child resource at a remote CSE, which may not be present as a child of an original resource or may not be an announced child thereof.

To support resource announcement, an additional column in a resource template may specify attributes to be announced for inclusion in an associated announced resource type. For each announced <resourceType>, the addition of suffix “Annc” to the original <resourceType> may be used to indicate its associated announced resource type. For example, resource <containerAnnc> may indicate the announced resource type for <container> resource, and <groupAnnc> may indicate the announced resource type for <group> resource.

Digital rights management (DRM) tools or technological protection measures (TPM) may be a set of access control technologies for restricting the use of proprietary hardware and copyrighted works. DRM technologies try to control the use, modification, and distribution of copyrighted works (such as software and multimedia content), as well as systems within devices that enforce these policies.

Although an M2M system supports its own access control policy (ACP), the M2M system may need to support OMA DRM if the content may be under the subject of OMA DRM and a specific license scheme may be described. For this, it may be desirable for the M2M system to support contents under DRM as a M2M resource. M2M applications that do not have enough computing power or memory to support DRM client may use OMA DRM contents via oneM2M platform that supports OMA DRM client functions. Hereinafter, a content under DRM or OMA DRM will be referred to as DRM content or OMA DRM content.

FIG. 6 illustrates an example of an architecture for managing a resource associated with OMA DRM in an M2M system according to the present disclosure. FIG. 6 illustrates an architecture including entities defined for managing DRM-related contents and information in an M2M platform according to embodiments of the present disclosure.

Referring to FIG. 6, an M2M system includes a mobile device 610, a secure contents provider 620, and a right issuer 630.

The mobile device 610 may be an end device of an M2M service. In the mobile device 610, an AE 612 corresponding to an M2M or IoT-related application may be executed. The AE 612 may be a subject that generates a request for a content and consumes a content.

The secure contents provider 620 provides a DRM content according to a request of the AE 612 of the mobile device 610. For this, the secure contents provider 620 includes a contents database (DB) 622, which stores contents, an IoT server 624 interworking with the AE 612, and a contents management block 626 which manages contents. The IoT server 624 operates as an IoT platform or an M2M platform and may interact with the AE 612 according to an M2M protocol.

According to various embodiments, the IoT server 623 includes a DRM interworking proxy entity (IPE), DRM-IPE 624a, and a DRM resource 624b. The DRM-IPE 624a performs an M2M interworking function for DRM (e.g., OMA DRM). As a logical entity, the DRM-IPE 624a may obtain information from an M2M system and interact with an OMA DRM server to check rights for the contents. The DRM resource 624b may be a resource under an M2M standard for DRM contents. The DRM resource 624b holds DRM contents (e.g., OMA DRM) as well as information necessary to use contents for the AE 612.

The right issuer 630 manages a right based on DRM. The right issuer 630 includes a right DB 632 for storing right information (e.g., right object (RO)) and a right management block 634 for controlling exchange of information on a right. The right management block 634 may interact with the content management block 626 and the DRM-IPE 624a in the IoT server 624.

The AE 612, which may be an M2M application, may download OMA DRM data stored in an M2M platform. For this, the AE 612 may send a request to the IoT platform to download OMA DRM contents. The IoT server 624 processes the request from the AE 612 and triggers an OMA DRM procedure via the OMA DRM-IPE 624a. The OMA DRM-IPE 624a downloads the requested contents and a right object for the contents. Herein, the OMA DRM-IPE 624a may behave as an OMA DRM client on behalf of the AE 612. The downloaded contents and the corresponding right object (RO) should be stored in a resource for the AE 612 with a proper ACP (e.g., number of reads, only accessible by the application). The AE 612 obtains a response for the success of OMA DRM download. When the AE 612 needs to access the downloaded contents, the AE 612 sends a request for the downloaded contents stored in a oneM2M platform. Accordingly, the DRM-IPE 624a performs decryption and provides the decrypted contents on behalf of the AE 612.

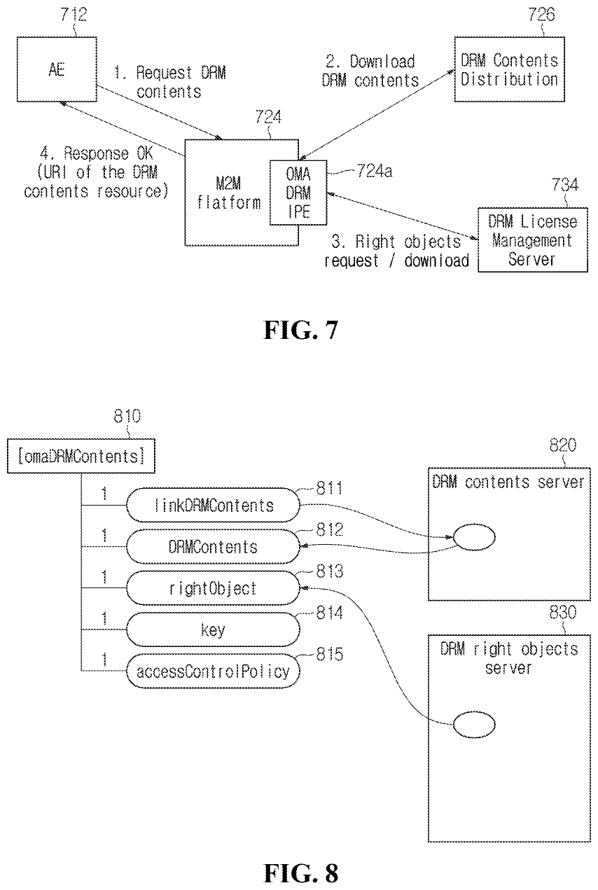

FIG. 7 illustrates interaction between entities associated with contents under OMA DRM in an M2M system according to the present disclosure. FIG. 7 illustrates interactions among an AE 712, an M2M platform 724, which includes an OMA DRM-IPE 724a, a DRM contents distributor 727, and a DRM license management server 734.

Referring to FIG. 7, the AE 712 requests OMA DRM contents to the M2M platform 724. Accordingly, the M2M platform 724 stores the OMA contents download request from the AE 712 and triggers an OMA DRM procedure via the OMA DRM-IPE 724a. The OMA DRM-IPE 724a downloads DRM contents requested from the DRM contents distributor 727 and downloads a right object for the DRM contents requested from the DRM license management server 734. Thus, the contents may be downloaded, and a right may be stored in a resource for the AE 712 with a proper ACP (e.g., number of reads, only accessible by the AE). Then, the AE 712 receives a response for success of OMA DRM download (e.g., OK). Herein, the response may include an access address of resource associated with the DRM contents (e.g., uniform resource identifier (URI)).

FIG. 8 illustrates an example of an architecture of a resource associated with OMA DRM in an M2M system according to the present disclosure. The names of resources and attributes shown in FIG. 8 may be merely examples, and each resource and each attribute may be referred to by other names.

Referring to FIG. 8, a resource associated with OMA DRM may be referred to as <omaDRMContents>. The <omaDRMContents> resource 810 includes linkDrmContents attribute 811, DRMContents attribute 812, rightObject attribute 813, key attribute 814, and accessControlPolicy attribute 815. The linkDrmContents attribute 811 indicates a link to contents stored in the DRM contents server 820, and the DRMContents attribute 812 stores contents stored in the DRM contents server or information associated with the contents. The rightObject attribute 813 stores a right object stored in the DRM right object server 730 or information associated with the right object. The meaning of each attribute may be described in Table 5 below.

TABLE 5

| Attribute | Description |
|---|---|
| linkDRMContents | A link to the DRM contents in DRM contents server |
| DRMContents | Actual contents of the downloaded DRM content |
| rightObject | Contains the contents of the right object |
| | for the downloaded contents |
| contentsKey | Contains contents key information to |
| | decrypt the downloaded contents |
| accessControlPolicy | Indicates an access control policy for the downloaded contents |

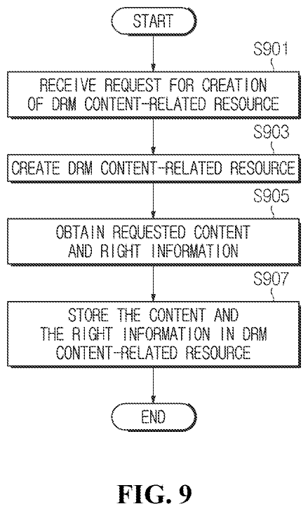

FIG. 9 illustrates an example of a procedure for creating a resource associated with DRM contents in an M2M system according to the present disclosure. The operation subject of FIG. 9 may be a device that operates as a CSE for managing a resource associated with DRM contents. In the description below, the operation subject of FIG. 8 may be referred to as ‘device’.

Referring to FIG. 9, at step S901, a device receives a request for creating a resource associated with DRM contents. The device receives a request message for requesting storage of a specific DRM content from an AE that wants to use DRM contents. The request message contains information on contents. For example, the information on contents may include at least one of information for identifying a requested content and information indicating that a content may be a DRM content.

At step S903, the device creates the resource associated with a DRM content. As the device confirms that the resource requested by the AE may be a DRM content, the device may determine that it may be necessary to create a resource associated with the DRM content. Alternatively, based on a format or type of information of the request message, the device may determine that it may be necessary to create a resource associated with the DRM content. Accordingly, the device may create a resource for storing information associated with the DRM content. For example, a resource associated with the DRM content may contain information associated with at least one of the location, right and read of the content. According to an embodiment, the resource associated with the DRM content may include at least one of a first attribute for accessing the content, a second attribute for storing the content, a third attribute associated with a right for the content, an fourth attribute associated with access control to the content, or an fifth attribute associated with decryption of the content. The use of first, second, third, fourth, and fifth attribute is not intended to require a specific number of attributes or that an attribute may be different from another attribute. The use of first, second, third, fourth, etc. is instead merely used as an identifier and a second attribute may be present without a first attribute, or the third and fourth attributes (or any combination of attributes) may be separate or integrated into the same attribute and not separate from each other.

At step S905, the device obtains the requested content and right information. The device may obtain the DRM content and right information based on information included in a resource associated with the DRM content. Specifically, the device may check information (e.g., URI, identification information) for accessing the requested content and download the DRM content from a server, which provides contents, by using the checked information. In addition, the device may check information for accessing the requested content (e.g., URI, identification information) and download right information (e.g., right object) on usage of the DRM content from a server, which manages rights of contents, by using the checked information. For this, the device may use a logical entity (e.g., OMA DRM-IPE) which has a right to perform a DRM-related procedure.

At step S907, the device stores the content and the right information in a resource associated with DRM contents. The device may store the obtained DRM content and the right information on the DRM content in at least one of attributes of the resource associated with DRM contents. Thus, the device holds and manages a resource containing the DRM content and the information associated with the DRM content.

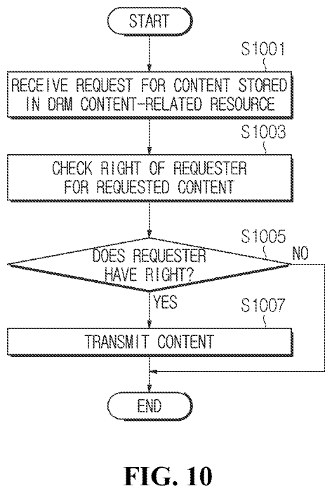

FIG. 10 illustrates an example of a procedure for providing contents stored in a resource associated with DRM contents in an M2M system according to the present disclosure. The operation subject of FIG. 10 may be a device that operates as a CSE for managing a resource associated with DRM contents. In the description below, the operation subject of FIG. 8 may be referred to as ‘device’.

Referring to FIG. 10, at step S1001, a device receives a request for a content stored in a resource associated with DRM contents. In other words, the device receives, from an AE, a request message for requesting a retrieval of a content stored in the resource associated with DRM contents. Herein, the AE, which sends the request message, may be identical with or different from an AE which requests to create a resource associated with DRM contents.

At step S1003, the device checks a right of a requester for the requested content. Herein, the requester means the AE which sends the request message received at step S1001. According to an embodiment, in order to check the right of the requester, the device may use information (e.g., right object) stored in a right-related attribute included in the resource associated with DRM contents. According to another embodiment, in order to check the right of the requester, the device may perform signaling with an external server that manages rights for DRM contents.

At step S1005, the device checks whether or not the requester has the right. For example, the device may check whether or not the information stored in the attribute states the right of the requester to read a DRM content. As another example, the device may check whether or not the requester has the right to read a DRM content via a server, which manages rights, by using the information stored in the attribute. When the requester has no right to read a DRM content, the device finishes the procedure.

On the other hand, when the requester has the right to read the DRM content, at step S1007, the device sends the content. The content may be stored in a state encrypted by DRM. In this case, based on information (e.g., key) stored in a right-related attribute included in the resource associated with DRM contents, the device may decrypt the DRM content and sends the decrypted content to the requester.

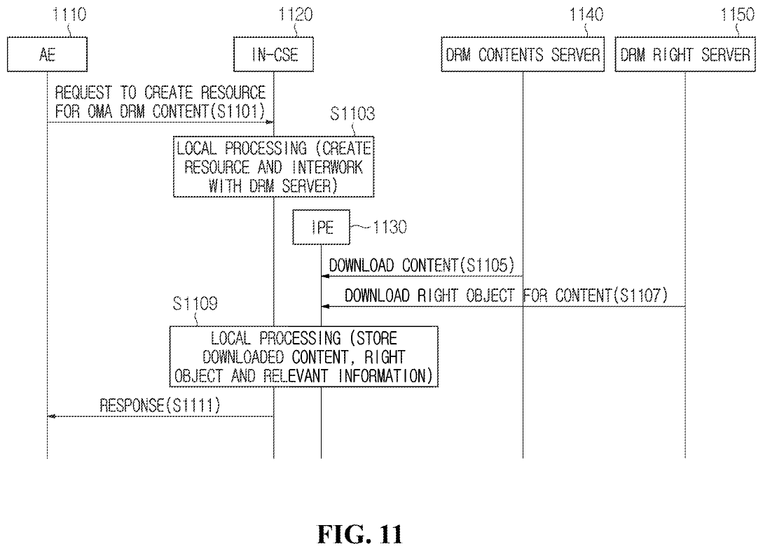

FIG. 11 illustrates an example of a procedure for creating a resource containing DRM contents and right information in an M2M system according to the present disclosure. FIG. 11 illustrates signal exchange among an AE 1110, an IN-CSE 1120, an IPE 1130, a DRM contents server 1140, and a DRM right server 1150. The AE 1110 may be an originator for creating a resource, and the IN-CSE 1120 may be an entity hosting a resource.

Referring to FIG. 11, at step S1101, the AE 1110 sends a message for requesting to create a resource for OMA DRM contents to the IN-CSE 1120. For this, the AE 1110 may send a message containing at least a part of information included in the resource for OMA DRM contents. For example, the resource for OMA DRM contents may be a <omaDRMContents> attribute.

At step S1103, the IN-CSE 1120 creates the resource for OMA DRM contents and interworks with DRM servers. Herein, the DRM servers include a DRM contents server 1140 and a DRM right server 1150. For example, the IN-CSE 1120 may create a <omaDRMContents> resource, and in order to set values of attributes contained in the <omaDRMContents> resource, the IN-CSE 1120 may obtain necessary information from the DRM right server 1150. Interworking with the DRM servers may be performed at steps S1105 to S1107 below.

At step S1105, the IN-CSE 1120 downloads a content from the DRM contents server 1140 via IPE 1130. For this, the IPE 1130 may request a content to the DRM contents server 1140. At step S1107, the IN-CSE 1120 downloads a right object for a content from the DRM right server 1150 via the IPE 1130. For this, the IPE 1130 may request a right object to the DRM right server 1150. Step S1105 and step S1107 may be understood as a part of the interworking with the DRM servers at step S1103.

At step S1109, the IN-CSE 1120 stores the content, the right object and relevant information, which may be received from DRM servers (e.g., the DRM contents server 1140, the DRM right server 1150). That is, the IN-CSE 1120 sets values of attributes included in the <omaDRMContents> based on the information received from the DRM servers. Herein, the relevant information may include key information for decryption of contents and restriction information (e.g., ACP) associated with usage of contents defined in an M2M platform.

At step S1111, the IN-CSE 1120 sends a response message to the AE 1110. The response message may be sent in response to the request message sent at step S1101. In the case of FIG. 11, the response message notifies that the requested resource is successfully created. Accordingly, the AE 1110 may recognize that a resource associated with an OAM DRM content may be created and the OAM DRM content may be retrieved.

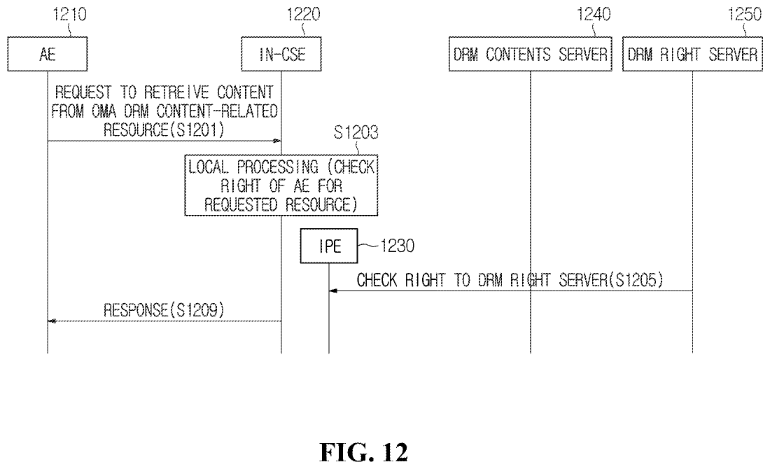

FIG. 12 illustrates an example of a procedure for providing DRM contents based on rights information in an M2M system according to the present disclosure. FIG. 12 illustrates signal exchange among an AE 1210, an IN-CSE 1220, an IPE 1230, a DRM contents server 1240, and a DRM right server 1250. The AE 1210 may be an originator for creating a resource, and the IN-CSE 1220 may be an entity hosting a resource.

Referring to FIG. 12, at step S1201, the AE 1210 sends a message for requesting a content retrieval from a resource associated with OMA DRM contents. In other words, the AE 1210 requests retrieval of a content in a resource associated with OMA DRM contents stored in the IN-CSE 1220.

At step S1203, the IN-CSE 1220 checks a right of the AE 1210 for the requested resource. The IN-CSE 1220 identifies the right of the AE 1210 for an OMA DRM content resource. Based on the request message received from the AE 1210, the IN-CSE 1220 may identify the right of the AE 1210, which may be associated with at least one of an ACP and right objects. In order to identify the right of the AE 1210, step S1206 below may be performed.

At step S1205, the IN-CSE 1220 checks the right of the AE 1210 by using the DRM right server 1250 via the IPE 1230. That is, the IPE 1230 may query the DRM right server 1250 about a right to read a content of the AE 1210 and receive a response. However, according to another embodiment, step S1205 may be skipped.

At step S1207, the IN-CSE 1220 sends a response message to the AE 1210. The response message may be sent in response to the request message sent at step S1201. In the case of FIG. 12, the response message contains a requested content. Herein, the IN-CSE 1220 may decrypt an encrypted content by using key information, which may be included in the resource associated with OMA DRM contents, and then may send the decrypted content.

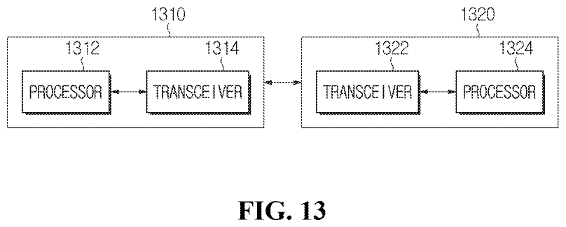

FIG. 13 illustrates a configuration of an M2M device in an M2M system according to the present disclosure. An M2M device 1310 or an M2M device 1320 illustrated in FIG. 13 may be understood as hardware functioning as at least one among the above-described AE, CSE and NSE.

Referring to FIG. 13, the M2M device 1310 may include a processor 1312 controlling a device and a transceiver 1314 transmitting and receiving a signal. Herein, the processor 1312 may control the transceiver 1314. In addition, the M2M device 1310 may communicate with another M2M device 1320. The another M2M device 1320 may also include a processor 1322 and a transceiver 1324, and the processor 1322 and the transceiver 1324 may perform the same function as the processor 1312 and the transceiver 1314.

As an example, the originator, the receiver, AE and CSE, which may be described above, may be one of the M2M devices 1310 and 1320 of FIG. 13, respectively. In addition, the devices 1310 and 1320 of FIG. 13 may be other devices. As an example, the devices 1310 and 1320 of FIG. 13 may be communication devices, vehicles, or base stations. That is, the devices 1310 and 1320 of FIG. 13 refer to devices capable of performing communication and may not be limited to the above-described embodiment.

The above-described exemplary embodiments of the present disclosure may be implemented by various means. For example, the exemplary embodiments of the present disclosure may be implemented by hardware, firmware, software, or a combination thereof.

The foregoing description of the exemplary embodiments of the present disclosure has been presented for those skilled in the art to implement and perform the disclosure. While the foregoing description has been presented with reference to the preferred embodiments of the present disclosure, it will be apparent to those skilled in the art that various modifications and variations may be made in the present disclosure without departing from the spirit or scope of the present disclosure as defined by the following claims.

Accordingly, the present disclosure is not intended to be limited to the exemplary embodiments shown herein but is to be accorded the widest scope consistent with the principles and novel features disclosed herein. In addition, while the exemplary embodiments of the present specification have been particularly shown and described, it is to be understood that the present specification is not limited to the above-described exemplary embodiments, but, on the contrary, it will be understood by those skilled in the art that various changes and modifications may be made without departing from the spirit and scope of the present specification as defined by the claims below, and such changes and modifications should not be individually understood from the technical thought and outlook of the present specification.

In this specification, both the disclosure and the method disclosure are explained, and the description of both inventions may be supplemented as necessary. In addition, the present disclosure has been described with reference to exemplary embodiments thereof. It will be understood by those skilled in the art that various changes in form and details may be made therein without departing from the essential characteristics of the present disclosure. Therefore, the disclosed exemplary embodiments should be considered in an illustrative sense rather than in a restrictive sense. The scope of the present disclosure is defined by the appended claims rather than by the foregoing description, and all differences within the scope of equivalents thereof should be construed as being included in the present disclosure.

What is claimed is:

1. A method for operating a first device in a machine-to-machine (M2M) system, the method comprising:
receiving, from a second device, a first message for requesting to create a resource associated with a content under digital rights management (DRM);
creating the resource based on the first message;
obtaining the content and right information on usage of the content from at least one external server;
storing the content and the right information in the resource; and
transmitting, to the second device, a second message for notifying that the resource is created.

2. The method of claim 1, wherein the first message includes at least one of information for identifying the content and information indicating that the content is a DRM content.

3. The method of claim 1, wherein the resource includes at least one of a first attribute for accessing the content, a second attribute for storing the content, a third attribute associated with a right for the content, a fourth attribute associated with access control to the content, or a fifth attribute associated with decryption of the content.

4. The method of claim 1, wherein the at least one external server includes a first server for providing the content and a second server for managing a right for the content, and
wherein the at least one external server is accessed via a DRM interworking proxy (DRM-IPE) that is a logical entity in the at least one external server.

5. The method of claim 1, further comprising:
receiving, from the second device, a third message for requesting retrieval of the content stored in the resource;
checking whether or not the second device has a right to read the content; and
transmitting to the second device a fourth message including the content.

6. The method of claim 5, wherein the checking of whether or not the second device has a right to read the content comprises checking information associated with a right for the content in the resource.

7. The method of claim 5, wherein the checking of whether or not the second device has a right to read the content comprises performing signaling with the at least one external server to check a right for the content.

8. The method of claim 5, wherein the transmitting of the fourth message comprises:
decrypting the content based on information on decryption of the content in the resource; and
transmitting the fourth message that includes the decrypted content.

9. A method for operating a second device in a machine-to-machine (M2M) system, the method comprising:
transmitting, to a first device, a first message for requesting to create a resource associated with a content under digital rights management (DRM); and
receiving, from the first device, a second message for notifying that the resource is created.

10. The method of claim 9, wherein the first message includes at least one of information for identifying the content and information indicating that the content is a DRM content.

11. The method of claim 9, wherein the resource includes at least one of a first attribute for accessing the content, a second attribute for storing the content, a third attribute associated with a right for the content, a fourth attribute associated with access control to the content, and a fifth attribute associated with decryption of the content.

12. The method of claim 9, further comprising:
transmitting, to the first device, a third message for requesting retrieval of the content stored in the resource; and
receiving, from the first device, a fourth message including the content.

13. A first device in a machine-to-machine (M2M) system, the first device comprising:
a transceiver; and
a processor coupled with the transceiver,
wherein the processor is configured to:
receive, from a second device, a first message for requesting to create a resource associated with a content under digital rights management (DRM),
create the resource based on the first message,
obtain the content and right information on usage of the content from at least one external server,
store the content and the right information in the resource, and
transmit, to the second device, a second message for notifying that the resource is created.

14. The first device of claim 13, wherein the first message includes at least one of information for identifying the content and information indicating that the content is a DRM content.

15. The first device of claim 13, wherein the resource includes at least one of a first attribute for accessing the content, a second attribute for storing the content, a third attribute associated with a right for the content, a fourth attribute associated with access control to the content, and a fifth attribute associated with decryption of the content.

16. The first device of claim 13, wherein the at least one external server includes a server for providing the content and a server for managing a right for the content, and
wherein the at least one external server is accessed via a DRM interworking proxy (DRM-IPE), which is a logical entity in the at least one external server.

17. The first device of claim 13, wherein the processor is further configured to:
receive, from the second device, a third message for requesting retrieval of the content stored in the resource,
check whether or not the second device has a right to read the content, and
transmit a fourth message including the content to the second device.

18. The first device of claim 17, wherein the processor is further configured to check information associated with a right for the content in the resource.

19. The first device of claim 17, wherein the processor is further configured to perform signaling with the at least one external server to check a right for the content.

20. The first device of claim 17, wherein the processor is further configured to:
decrypt the content based on information on decryption of the content in the resource, and
transmit the fourth message that includes the content as decrypted.
